(19) United States
(12) Patent Application Publication
(10) Pub. No.: US 2004/0171785 A1
(43) Pub. Date: Sep. 2, 2004

(54) Polyurethane coating systems

(76) Inventors: Christoph Gurtler, Koln (DE); Jan Mazanek, Koln (DE); Joachim Petzoldt, Monheim (DE); Heinz Schmidt, Erftstadt (DE); Stephan Nowak, Koln (DE)

Correspondence Address: BAYER POLYMERS LLC, 100 BAYER ROAD, PITTSBURGH, PA, 15205, US

(21) Appl. No.: 10/784,018

(22) Filed: Feb. 20, 2004

(30) Foreign Application Priority Data
Feb. 26, 2003 (DE) 10308104.6

(51) Int. Cl. C08G 18/81; C08J 9/00

(52) U.S. Cl. 528/45; 528/56; 528/57

(57) ABSTRACT

Novel one-component polyurethane systems, to their preparation and use for preparing paints, inks and adhesives. The one-component polyurethane systems include one or more organic and/or inorganic compounds of molybdenum and/or of tungsten in which the molybdenum and/or tungsten has an oxidation state of at least +4.

### CROSS REFERENCE TO RELATED PATENT APPLICATION

The present patent application claims the right of priority under 35 U.S.C. § 119 (a)-(d) of German Patent Application No.103 08 104.6, filed Feb. 26, 2003.

### FIELD OF THE INVENTION

The present invention relates to novel one-component polyurethane systems, to their preparation and use for preparing paints, inks and adhesives.

### BACKGROUND OF THE INVENTION

One-component (1K) baking systems based on polyurethane are heat-curable materials, stable on storage at room temperature, for preparing paints, inks and adhesives. They consist in general of blocked polyisocyanates which in the course of thermal curing are consumed by reaction with hydroxyl-containing polyesters, polyacrylates, other hydroxy-functional polymers and/or mixtures of different polymers. Another possibility to obtain raw materials for baking enamels which are stable on storage at room temperature is the partial blocking of the isocyanate groups of polymers containing both blocked isocyanate groups and hydroxyl groups.

The principal compounds used to block polyisocyanates and 1K baking systems are ε-caprolactam, methyl ethyl ketoxime (butanone oxime), secondary amines and also triazole and pyrazole derivatives, as described for example in EP-A 0 576 952, EP-A 0 566 953, EP-A 0 159 117, U.S. Pat. No. 4,482,721, WO 97/12924 or EP-A 0 744 423. Malonate blocking is also possible. With this kind of blocking, however, the blocking agent is not cleaved back; instead, a transesterification reaction takes place on the diethyl malonate radical.

Depending on the blocking agent used, temperatures of 100-160° C. are employed in producing coatings from the 1K PU baking systems. The selection of the appropriate blocking agent for the particular system, however, is made not only according to the baking temperature. Other factors, such as yellowing tendency, odour and storage stability of the systems, for example, also play an important part. Since especially in recent times a concern has been to minimize the baking temperature of coating systems, it is necessary in each case to find a compromise in terms of the composition of the coating materials and the properties of the coating. From this it is evident that there is a need for new baking systems which have optimum performance properties even at relatively low baking temperatures.

In the past already a large number of experiments have been undertaken aimed at lowering the baking temperature of 1K systems through the use of catalysts. Thus in EP-A 0 761 705, for example, organic bismuth compounds are claimed for the catalysis of partly or fully blocked polyisocyanates. U.S. Pat. No. 5,859,165 describes reaction products of manganese, cobalt, nickel, copper, zinc, germanium, antimony or bismuth and/or their oxides as catalysts for blocked poly(thio)isocyanates. EP-A 0 726 284 describes in general terms metal salts and/or metal complexes for catalysing the reaction of blocked polyisocyanates with polyols, although the examples disclose only dibutyltin dilaurate and dibutyltin acetate specifically.

In order to reduce the use of organic solvents and hence to reduce the emission of these solvents into the environment, and in order to improve working conditions on the coating line through reduced solvent emission, recent years have seen the development of 1K coating systems comprising water as a predominant solvent component. An overview of this technology is given by D. A. Wicks and Z. W. Wicks in Progress in Organic Coatings 2001, 41(1-3), 1-83. This technology is spreading. The presence of the aqueous solvent and/or dispersion medium imposes different requirements regarding the use of catalysts than is the case with what are termed solvent-borne systems. Thus in the latter systems, when using catalysts, there is no need to ensure that the catalyst used is stable to water or to hydrolysis. Consequently, the common catalysts employed in solvent-borne 1K systems cannot generally be used in what are termed aqueous systems. Known representatives of such catalysts, which possess a high activity (i.e. a marked reduction in the baking temperatures) include, for example, bismuth 2-ethylhexanoate and organic tin(IV) compounds such as dibutyltin dilaurate (DBTL). Besides these a range of further compounds have been disclosed, described in the above-cited article by Wicks et al. It is also known that bismuth carboxylates are hydrolysed in water.

To date only a few catalysts have been disclosed for accelerating the curing of aqueous one-component systems. WO 95/04093 outlines organotin-based systems. These are catalysts which are used in particular in systems for electrocoating, where curing normally takes place at high temperatures of approximately 170° C. or more. The blocking agents and polyisocyanates used in each case are not specified in the examples. However, owing to ecological considerations, the use of organotin catalysts is not desirable. The activity of these and other catalysts in comparison to other catalyst systems is also described in the following application.

The Description of WO 00/47642, page 4, cites very specific examples of catalysts for 1K aqueous applications. Thus organotin compounds and lead compounds are described whose use in coatings, however, is not desirable, from standpoints of ecology.

WO 00/47642 also contains a reference to a catalyst for aqueous one-component systems which is based on the reaction of bismuth oxide with a carboxylic acid having a carbon chain length of from C₁₁ to C₃₆. Although hydrolysis of the catalyst takes place with this system as well, the catalyst is said to reform from the constituents at the relatively high baking temperatures of more than 165° C. up to 180° C. and to possess a high catalytic activity. The use of this catalyst system, however, is tied to very specific resins and/or alcohol components.

The activity of the catalyst system described is described only for specific resins in this case, cationically hydrophilicized resins, i.e. resins obtained by reacting, for example, an expoxy resin containing bisphenyl A with an amine. Depending on the amine used (primary, secondary, tertiary) and in the presence of an excess of the epoxy resin and in the presence of water and neutralizing acid it is also possible for quaternary ammonium groups to form. Hence the resin is in principle amine-containing, which is unsuitable for the development of an automotive surfacer that is intended to have low yellowing and good long-term stability.

As an alternative to cationic hydrophilicization it would be possible to prepare an aqueous 1K PU system by adding surface-active substances or emulsifiers. The catalyst system presented therein is not described for such a coating system of this kind.

Also possible is hydrophilicization with, for example, anionic hydrophilicizers (e.g. by carboxylic acids) or nonionic hydrophilicizers such as, for example, by polyethers (incorporated into the resin and not as an individual constituent, as in the case of the emulsifiers) for the preparation of an aqueous 1K system. The catalyst system presented therein, however, has likewise not been described for such a coating system.

On the basis of the different possibilities of hydrophilicizing 1K systems (cationically, by emulsifiers, by anionic or nonionic hydrophilicization) the use and activity of the catalyst system described in WO 00/47642 in systems other than cationically hydrophilicized systems is not obvious. For example, cationic hydrophilicizing can act through ammonium salts as a ligand for stabilization. This stabilizing effect is absent in the 1K systems, which are not cationically hydrophilicized.

Moreover, the aforementioned publication describes only alcohol-blocked isocyanates. A typical blocking agent for blocking the isocyanate exclusively described therein, (polymeric) MDI (methylene-phenyl diisocyanate), is butoxyethoxyethanol (butyl carbitol). In addition, 2-ethoxyethanol and 2-methoxyethanol are also cited. The elimination of this blocking agent (in actual fact a urethane cleavage) requires high temperatures: baking is carried out at temperatures of 165-180° C. over a period of 20 minutes.

For the intended use as coating composition for passenger cars it is desirable to find catalysts which allow a one-component system to be cured at temperatures of not more than 140° C., and preferably at an even lower temperature. Accordingly, no catalyst is known at present whose use in aqueous systems based on a broad spectrum of blocking agents, blocked (poly)isocyanates and hydrophilicizing methods would allow the baking temperatures to be lowered to the desired level.

The object was therefore to find a catalyst suitable for general use which is effective at low baking temperatures and with a multiplicity of blocking agents and resins and hydrophilicizing agents. Account ought at the same time to be taken of ecological aspects.

### SUMMARY OF THE INVENTION

The present invention is directed to polyurethane-based one-component baking systems that include one or more organic and/or inorganic compounds of molybdenum and/or of tungsten in which the molybdenum and/or tungsten has an oxidation state of at least +4.

Embodiments of the invention provide the systems described prepared by introducing the organic and/or inorganic compounds of molybdenum and/or of tungsten into blocked polyisocyanates and/or polymers having polyisocyanate-reactive groups prior to dispersing or dissolution thereof in water and/or organic solvents or solvent mixtures. In an alternative embodiment, the molybdenum and/or tungsten compounds are introduced into water and/or organic solvents or solvent mixtures prior to the dispersing or dissolution of blocked polyisocyanates and/or polymers having polyisocyanate-reactive groups in the same. In another alternative embodiment, the molybdenum and/or tungsten compounds are added to one or more materials selected from blocked polyisocyanates, polymers having polyisocyanate-reactive groups, organic solvents, and optionally further additives and auxiliaries, before adding dispersing water.

The present invention is also directed to a method of preparing paints, inks and adhesives that includes adding to the above-described systems, one or more materials selected from the group consisting of pigments, fillers, levelling agents, defoamers, catalysts other than the inorganic compounds of molybdenum and/or of tungsten, and mixtures thereof. Embodiments of the invention are further directed to substrates coated with coatings obtainable from the systems described above.

### DETAILED DESCRIPTION OF THE INVENTION

Other than in the operating examples, or where otherwise indicated, all numbers or expressions referring to quantities of ingredients, reaction conditions, etc. used in the specification and claims are to be understood as modified in all instances by the term “about.”

The object of the invention has been achieved with the provision of the catalysts of the invention based on certain molybdenum and/or tungsten compounds.

The use of molybdenum compounds and/or tungsten compounds to catalyse blocked polyisocyanates and one-component baking systems was hitherto unknown. Particularly suitable for catalyst use are the compounds of molybdenum and/or of tungsten in their higher oxidation states. Compounds of molybdenum, for example, in oxidation state +6 (e.g. lithium molybdate and sodium molybdate; see also U.S. Pat. No. 2,916,464 on the preparation of polyurethane foams) or else in Saunders/Frisch: High Polymers, Vol. XVI (1962), p. 169) have been used to catalyse the reactions of non-blocked isocyanates with alcohols. Accelerating the reaction of blocked isocyanates with polyols, for example, in the presence of molybdenum compounds was therefore not suggested by the prior art.

It has been found that through the use of the catalysts of the invention in 1K systems based on blocked isocyanates it is possible, depending on the blocking agent used, to lower the baking temperature by about 20° C. Accordingly it is possible to attain low baking temperatures of approximately 130° C. The catalysts of the invention, however, are sufficiently active even at a low temperature, for example 120° C., as is shown in the examples below.

The present invention provides polyurethane-based one-component baking systems characterized in that they comprise one or more organic and/or inorganic compounds of molybdenum and/or of tungsten in which the molybdenum and/or tungsten has an oxidation state of at least +4.

These one-component systems are preferably characterized in that they comprise

(a) blocked polyisocyanates,

(b) polymers having polyisocyanate-reactive groups,

(c) one or more organic and/or inorganic compounds of molybdenum and/or of tungsten in which the molybdenum and/or tungsten has an oxidation state of at least +4,

(d) water and/or organic solvents or solvent mixtures and

(e) if desired, further additives and auxiliaries,

the amounts of (a)+(b) being from 20 to 89.9 parts by weight, (c) from 0.01 to 5 parts by weight, (d) from 10 to 0.70 parts by weight and (e) from 0 to 10 parts by weight and the sum of the parts by weight of components (a) to (e) being 100.

The invention also provides processes for preparing the one-component baking systems of general composition (a) to (e).

The invention further provides for the use of the one-component baking systems of the invention for preparing paints, inks and other baking systems such as adhesives or elastomers and provides the coatings produced therefrom.

The 1K baking systems of the invention comprise, as a crosslinker component, blocked polyisocyanates (a) such as are obtainable in conventional manner by reacting any desired organic polyisocyanates A) with any desired blocking agents B) and, if desired, further synthesis components C). Suitable polyisocyanates A) for preparing the blocked polyisocyanates (a) are any desired organic polyisocyanates which are known from the conventional polyurethane systems for crosslinking compounds containing active hydrogen, i.e. aliphatic polyisocyanates, including the cycloaliphatic polyisocyanates, aromatic polyisocyanates and heterocyclic polyisocyanates having at least two isocyanate groups, and mixtures thereof. Typical examples of suitable polyisocyanates A) are aliphatic isocyanates such as di- or triisocyanates, e.g. butane diisocyanate (BDI), pentane diisocyanate, hexane diisocyanate (HDI), 4-isocyanatomethyl-1,8-octane diisocyanate (triisocyana-tononane, TIN) or cyclic systems, such as 4,4′-methylenebis(cyclohexyl isocyanate) (Desmodur® W, Bayer AG, Leverkusen), 3,5,5-trimethyl-1-isocyanato-3-isocyanatomethylcyclohexane (IPDI) and ω,ω′-diisocyanato-1,3-dimethylcyclo-hexane (H₆XDI). Examples of aromatic polyisocyanates are 1,5-naphthalene diisocyanate, diisocyanatodiphenylmethane (MDI) or crude MDI, diisocyanato-methylbenzene (TDI), particularly the 2,4 and 2,6 isomers, and technical-grade mixtures of the two isomers, and also 1,3-bis(isocyanatomethyl)benzene (XDI). Likewise highly suitable as well are polyisocyanates obtainable by reacting the di- or triisocyanates with themselves via isocyanate groups, such as uretdiones or carbodiimide compounds or such as isocyanurates or iminooxadiazinediones, which are formed by reaction of three isocyanate groups.

Other suitable polyisocyanates include oligomeric polyisocyanates having biuret, allophanate and acylurea structural elements, and also any desired mixtures of the stated polyisocyanates. Mixtures of polyisocyanates having the stated structural units and/or mixtures of the modified polyisocyanates with the monomeric isocyanates can also be used. The polyisocyanates thus modified can also be proportionally prepolymerized with other isocyanate-reactive groups. Proportionally modified polyisocyanates are much preferred. Likewise highly suitable are polyisocyanate prepolymers containing on average more than one isocyanate group per molecule. They are obtained by preliminary reaction of a molar excess of, for example, one of the abovementioned di, tri- or polyisocyanates and modified polyisocyanates with an organic material having at least two active hydrogen atoms per molecule, in the form of hydroxy groups, for example. They, similarly, can be proportionally prepolymerized as described in the next section.

Additionally suitable are low molecular mass polyisocyanates containing urethane groups, as may be obtained by reacting diisocyanates used in excess, preferably IPDI or TDI, with simple polyhydric alcohols of the molecular weight range 62-300, in particular with trimethylolpropane or glycerol.

Suitable polyisocyanates A) further include the known prepolymers containing terminal isocyanate groups, as are obtainable in particular by reacting the abovementioned simple polyisocyanates, especially diisocyanates, with substoichiometric amounts of organic compounds having at least two isocyanate-reactive functional groups. In these known prepolymers the ratio of isocyanate groups to NCO reactive hydrogen atoms is from 1.05:1 to 10:1, preferably from 1.1:1 to 3:1, the hydrogen atoms originating preferably from hydroxyl groups. The nature and proportions of the starting materials used in preparing NCO prepolymers are otherwise preferably chosen such that the NCO prepolymers preferably have an average NCO functionality of from 2 to 3 and a number-average molar mass of 500-10 000, preferably 800-4000.

Preferred polyisocyanates A) are those which include a uretdione, isocyanurate, iminooxadiazinedione, acylurea, urethane, biuret or allophanate structure, preference being given to those polyisocyanates based on 1,6-hexamethylene diisocyanate, 3,5,5-trimethyl-1-isocyanato-3-isocyanatomethylcyclohexane (IPDI), ω,ω′-diisocyanato-1,3-dimethylcyclohexane (H₆XDI) and 4,4′-methylenebis(cyclohexyl isocyanate) (Desmodur® W, Bayer AG, Leverkusen).

Additionally suitable as polyisocyanates A) in the sense of the invention are those polyurethane-, polyester- and/or polyacrylate-based polymers, containing free isocyanate groups, and also, where appropriate, mixtures thereof, in which only some of the free isocyanate groups are reacted with blocking agents while the remainder are reacted with an excess of hydroxyl-containing polyesters, polyurethanes and/or polyacrylates and also, where appropriate, mixtures thereof to form a polymer which contains free hydroxyl groups and which on heating to appropriate baking temperatures, without the addition of further components, crosslinks isocyanate groups reactive groups (self-crosslinking one-component baking systems).

All polyisocyanates mentioned can also be used as any desired mixtures with one another or else with other crosslinkers such as with melamine resins to prepare paints, inks and other formulations.

Suitable blocking agents B) include N—H or O—H functional compounds, which are consumed by reaction with isocyanates and which at appropriate temperature allow a crosslinking reaction with a further N—H or O—H functional compound. Examples of suitable blocking agents are dimethylpyrazole, diisopropylamine, tert-butylbenzylamine, butanone oxime, ε-caprolactam, ethoxyethanol, isopropoxy-ethanol and other alcohols such as carbitols. It is also possible to use secondary amines such as dibutylamine, for example, or other oximes, such as cyclohexanone oxime or else acetone oxime, for example. An overview of blocking agents suitable in principle can be found, for example, in Wicks et al. in Progress in Organic Coatings 1975, 3, pp. 73-79, 1981, 9, pp. 3-28 and 1999, 36, pp. 148-172. Preference is given to using 3,5-dimethylprazole, diisopropylamine, tert-butylbenzylamine, butanone oxime and ethoxyethanol.

The ratio of isocyanate groups to the blocking agent is generally 1:1 but can also adopt a value of from 0.5:1 to 2:1. Preference is given to a ratio of from 0.9:1 to 1.1:1, with particular preference from 0.95:1 to 1:1.

The blocked polyisocyanates (a) can be prepared by conventional methods. For example, one or more polyisocyanates can be introduced as an initial charge and the blocking agent can be metered in with stirring (over the course of about 10 minutes, for example). Stirring is continued until free isocyanate is no longer detectable. It is also possible to block one or more polyisocyanates with a mixture of two or more blocking agents (including where appropriate non-inventive blocking agents). The blocked polyisocyanates can of course also be prepared in solvents. These solvents either can be distilled off again in the subsequent preparation steps or else they remain in the product.

A further possibility for preparing the blocked polyisocyanates (a) used in accordance with the invention involves hydrophilicizing them ionically, nonionically or by both methods, in accordance with conventional processes, and adding water and then dissolving or dispersing them therein. In preparing the polyisocyanates it is also possible to use catalysts, cosolvents and other auxiliaries and additives. The preparation of the aqueous one-component baking systems can also take place such that non-blocked or only part-blocked polyisocyanates are mixed with polyesters, polyacrylates, polyacrylate-modified and polyurethane-modified polyesters containing hydrophilic groups and then are converted into a dispersion.

Suitable further synthesis components C include ionic or potentially ionic compounds C1) and/or, as nonionic hydrophilicizing agents, compounds C2. Examples of ionic or potentially ionic compounds C1 are mono- and dihydroxycarboxylic acids, mono- and diaminocarboxylic acids, mono- and dihydroxysulphonic acids, mono- and diaminosulphonic acids and mono- and dihydroxyphosphonic acids and/or mono- and diaminophosphonic acids and their salts such as dimethylolpropionic acid, hydroxypivalic acid, N-(2-aminoethyl)-β-alanine, 2-(2-aminoethylamino)ethanesulphonic acid, ethylenediamine-propyl- or butylsulphonic acid, 1,2- or 1,3-propylenediamine-β-ethylsulphonic acid, lysine, 3,5-diaminobenzoic acid, the hydrophilicizing agent from Example 1 of EP-A 0 916 647 and its alkali metal and/or ammonium salts; the adduct of sodium bisulphite with but-2-ene-1,4-diol, polyethersulphonate, the propoxylated adduct of 2-butenediol and NaHSO₃ (e.g. in DE-A 2 446 440, page 5-9, formula I-III) and also units which can be converted into cationic groups, such as N-methyldiethanol-amine, as hydrophilic synthesis components.

Preferred ionic or potentially ionic compounds C1 are those which possess carboxy or carboxylate and/or sulphonate groups and/or ammonium groups. Particularly preferred ionic compounds are those containing carboxyl and/or sulphonate groups as ionic or potentially ionic groups, such as the salts of N-(2-aminoethyl)-β-alanine, 2-(2-amino-ethylamino)ethanesulphonic acid, of the hydrophilicizing agent from Example 1 of EP-A 0 916 647 and of dimethylolpropionic acid.

As synthesis components C3 it is also possible to use those described below as compounds (b).

The hydroxyl components included among the described components C1, C2 and C3 can contain double bonds, which may originate, for example, from long-chain aliphatic carboxylic acids or fatty alcohols. Functionalization with olefinic double bonds is possible, for example, through the incorporation of allylic groups or of acrylic acid or methacrylic acid and also their respective esters. This raises the possibility of utilizing these substances for subsequent oxidative crosslinking using siccatives (Co⁺³) in the presence of atmospheric oxygen compounds or, through UV irradiation, for a further crosslinking.

Through the interaction and/or reaction of components (a) to (e), after dispersion in and/or with water, so-called PU dispersions are obtained which in essence are aqueous 1K PU coating systems. These PU dispersions may further comprise nonionically hydrophilicizing compounds C2 such as, for example, polyoxyalkylene ethers having at least one hydroxy or amino group. These polyethers include a fraction of from 30% by weight to 100% by weight of units derived from ethylene oxide: Those suitable include polyethers of linear construction with a functionality of between 1 and 3, but also compounds of the general formula (VI),

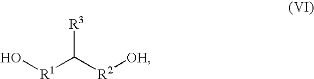

in which

R¹ and R² independently of one another are each a divalent aliphatic, cycloaliphatic or aromatic radical having 1 to 18 carbon atoms, which may be interrupted by oxygen and/or nitrogen atoms, and

R³ is a non-hydroxy-terminated polyester or, preferably, polyether.

With particular preference R³ is an alkoxy-terminated polyethylene oxide radical.

Nonionically hydrophilicizing compounds used as further synthesis component C2 also include, for example, polyalkylene oxide polyether alcohols which are monovalent and contain on average per molecule from 5 to 70, preferably from 7 to 55 ethylene oxide units, these alcohols being as obtainable conventionally by alkoxylating suitable starter molecules (e.g. in Ullmanns Encyclopädie der technischen Chemie, 4th edition, volume 19, Verlag Chemie, Weinheim pp. 31-38). Examples of suitable starter molecules include saturated monoalcohols such as methanol, ethanol, n-propanol, isopropanol, n-butanol, isobutanol, sec-butanol, the isomers pentanols, hexanols, octanols and nonanols, n-decanol, n-dodecanol, n-tetradecanol, n-hexadecanol, n-octadecanol, cyclohexanol, the isomeric methylcyclohexanols or hydroxymethylcyclohexane, 3-ethyl-3-hydroxymethyl-oxetane, or tetrahydrofurfuryl alcohol; diethylene glycol monoalkyl ethers such as diethylene glycol monobutyl ether, for example; unsaturated alcohols such as allyl alcohol, 1,1-dimethylallyl alcohol or oleyl alcohol, aromatic alcohols such as phenol, the isomeric cresols or methoxyphenols, araliphatic alcohols such as benzyl alcohol, anisyl alcohol or cinnamyl alcohol; secondary monoamines such as dimethylamine, diethylamine, dipropylamine, diisopropylamine, dibutylamine, bis-(2-ethylhexyl)amine, n-methyl- and n-ethylcyclohexylamine or dicyclohexylamine, and heterocyclic secondary amines such as morpholine, pyrrolidine, piperidine or 1H-pyrazole.

Preferred starter molecules are saturated monoalcohols and also diethylene glycol monoalkyl ethers. It is particularly preferred to use diethylene glycol monobutyl or methyl ether as starter molecule.

Alkylene oxides suitable for the alkoxylation reaction are, in particular, ethylene oxide and propylene oxide, which can be used in either order or else in a mixture in the alkoxylation reaction.

The polyalkylene oxide polyether alcohols are either pure polyethylene oxide polyethers or mixed polyalkylene oxide polyethers at least 30 mol % preferably at least 40 mol % of whose alkylene oxide units consist of ethylene oxide units. Preferred nonionic compounds are monofunctional mixed polyalkylene oxide polyethers containing at least 40 mol % ethylene oxide units and not more than 60 mol % propylene oxide units.

The PU dispersions of the invention can also be hydrophilicized using combinations of ionic and nonionic hydrophilicizing agents. Alternatively it is also possible to use cationic hydrophilicizing agents. If the former is the case, then preference is given to using combinations of anionic and nonionic hydrophilicizing agents.

The polyisocyanates are, as described above, either self-crosslinking polymers or else crosslinkers for any desired compounds containing polyisocyanate-reactive groups (b). Suitable compounds of the stated type (b), which can also be used as mixtures, include the following:

Polyhydroxy polyesters, polyhydroxy polyethers or hydroxyl-containing addition polymers, examples being the polyhydroxy polyacrylates known per se. The compounds generally have a hydroxyl number of from 20 to 200, preferably from 50 to 130, based on products in 100% form.

The polyhydroxyl polyacrylates are conventional copolymers of styrene with simple esters of acrylic acid and/or methacrylic acid, with the additional use, in order to introduce the hydroxyl groups, of hydroxyalkyl esters, such as the 2-hydroxyethyl, 2-hydroxypropyl, 2-, 3- or 4-hydroxybutyl esters of these acids, for example.

Suitable polyether polyols are the ethoxylation products and/or propoxylation products, known per se from polyurethane chemistry, of suitable di- to tetravalent starter molecules such as water, ethylene glycol, propanediol, trimethylolpropane, glycerol and/or pentaethyritol, for example.

Examples of suitable polyester polyols are in particular the reaction products, known per se in polyurethane chemistry, of polyhydric alcohols, for example alkanepolyols, of the type just exemplified with excess amounts of polycarboxylic acids and/or polycarboxylic anhydrides, especially dicarboxylic acids and/or dicarboxylic anhydrides. Examples of suitable polycarboxylic acids and polycarboxylic anhydrides are adipic acid, phthalic acid, isophthalic acid, phthalic anhydride, tetrahydrophthalic anhydride, hexahydrophthalic anhydride, maleic acid, maleic anhydride, their Diels-Alder adducts with cyclopentadiene, fumaric acid or dimeric and/or trimeric fatty acids. In the preparation of the polyester polyols it is of course possible to use any desired mixtures of the exemplified polyhydric alcohols or any desired mixtures of the exemplified acids and acid anhydrides.

The polyester polyols are prepared by known methods, as described for example in Houben-Weyl, Methoden der organischen Chemie, volume XIV/2, G. Thieme-Verlag, 1963, pages 1 to 47. Hydrophilic modification of these polyhydroxyl compounds, where necessary, takes place in accordance with conventional methods, as disclosed for example in EP-A 0 157 291 or EP-A 0 427 028.

It is also possible to use mixtures of these polyols or else other combinations, polyacrylate-modified and/or polyurethane-modified polyesters.

Suitable polyol components (b) in the one-component systems of the invention also include dihydric to hexahydric alcohols and/or mixtures thereof which contain no ester groups. Typical examples are ethane-1,2-diol, propane-1,2- and -1,3-diol, butane-1,4, -1,2- or -2,3-diol, hexane-1,6-diol, 1,4-dihydroxycyclohexane, glycerol, trimethylolethane, trimethylolpropane, pentaerythritol and sorbitol. It is of course also possible to use alcohols having ionic groups or groups which can be converted into ionic groups. Preference is given for example to 1,4- or 1,3-butanediol, 1,6-hexanediol and/or trimethylolpropane.

In the preparation of the one-component baking systems of the invention it is also possible as component (b) to use compounds containing amino groups such as ethanolamine and its derivatives. Diamines, too, such as hexamethylenediamine, ethylenediamine; isophoronediamine or hydrazine and/or its derivatives can be used.

The ratio of the groups which are reactive towards the blocked isocyanates to the blocked isocyanates can be varied within a wide range and will generally be from 0.5:1 to 2:1. It is preferred to operate in a ratio of 1:1 or 1.5:1.

The one-component baking enamels of the invention comprise organic and/or inorganic molybdenum compounds as catalysts (c) for accelerating the crosslinking reaction.

Suitable molybdenum compounds and/or tungsten compounds include all known compounds of molybdenum and/or of tungsten in which they have an oxidation state of greater than or equal to +4, for example +5 and +6. They can be soluble or partially soluble or else insoluble in the one-component baking system for catalysis. They can be organic or else inorganic in nature; it is also possible to use mixtures of different molybdenum compounds and/or tungsten compounds, and also mixtures of the molybdenum compounds and/or tungsten compounds with other catalysts such as amines and/or tin compounds or bismuth compounds.

Examples of compounds of molybdenum and/or of tungsten which can be used in accordance with the invention can be selected from the group consisting of ammonium molybdate, lithium molybdate, sodium molybdate, potassium molybdate, rubidium molybdate, caesium molybdate, ammonium paramolybdate (NH₄)₆Mo₇O₂₄.4H₂O, molybdenyl bisacetylacetonate MoO₂(C₅H₇O₅)₂, molybdenum dioxide tetramethylheptadionate MoO₂(TMHD)₂, molybdenum alkoxides formed from 1,2-, 1,3- or 1,4-diols such as ethylene glycol, propylene glycol or 1,4-butanediolmolybdic acid, molybdenum oxides, tetraethylammonium molybdate, sodium tungstate, magnesium molybdate, calcium molybdate, tungstic acid, lithium tungstate and phosphotungstic acid.

Preference is given in the sense of the invention to compounds of molybdenum and/or of tungsten in oxidation state +6. Preference is therefore given to derivatives of molybdic and/or tungstic acid. These are, for example, compounds from the group consisting of ammonium molybdate, lithium molybdate, sodium molybdate, potassium molybdate, rubidium molybdate, caesium molybdate, ammonium paramolybdate (NH₄)₆Mo₇O₂₄.4H₂O, molybdenyl bisacetylacetonate MoO₂(C₅H₇O₅)₂, molybdenum dioxide tetramethylheptadionate MoO₂(TMHD)₂, molybdenum alkoxides formed from 1,2-, 1,3- or 1,4-diols such as ethylene glycol, propylene glycol or 1,4-butanediol, molybdic acid, molybdenum oxides, tetraethylammonium molybdate and sodium tungstate.

These are in particular ammonium, lithium, sodium and potassium molybdate and tungstate, ammonium paramolybdate (NH₄)₆Mo₇O₂₄.4H₂O, molybdenyl bisacetylacetonate MoO₂(C₅H₇O₅)₂, molybdenum bistetramethylheptadionate MoO₂(TMHD)₂, molybdenum alkoxides of 1,2-, 1,3- or 1,4-diols such as ethylene glycol, propylene glycol or 1,4-butanediol, and molybdic acid.

Apart from the abovementioned compounds the species in question can comprise complexes with alcohols, phenols, sugars, organic acids, (poly)ethers, etc. Lithium molybdate and sodium molybdate are particularly preferred.

The molybdenum compounds and/or tungsten compounds are added in amounts of from 0.01 to 5% by weight, preferably from 0.1 to 2% by weight, with particular preference from 0.2 to 1% by weight, based on the sum of components (a), (b) and (e). The addition can be made to any of components (a), (b), (d) or (e) or to mixtures thereof, either during the preparation or subsequently, to the respective component or to the finished coating material. Preference is given to addition during the preparation either to component (a) or (b) or to mixtures thereof. In aqueous systems the molybdenum compounds and/or tungsten compounds of the invention are added to the respective components with particular preference before the dispersing water is added. The molybdenum compounds and/or tungsten compounds of the invention can be added as finely ground solids, as a suspension in the desired liquids or as a solution.

The one-component baking systems of the invention comprise as solvent (d) water and/or organic solvents or mixtures thereof.

As organic solvents it is possible to use all known solvents. Preference is given to the solvents used in the paints industry such as xylene, butyl acetate, ethyl acetate, butylglycol acetate, methoxypropyl acetate, hydrocarbons such as Solvesso 100® (Exxon Chemicals), N-methylpyrrolidone.

Besides the blocked polyisocyanates (a) and polyols (b) it is possible to add customary additives and other auxiliaries (e) to the formulations (examples being pigments, fillers, levelling agents, defoamers, catalysts) and, if desired, catalysts other than (c) as well.

The paints, inks and other formulations are prepared from the one-component baking systems of the invention by conventional methods. Irrespective of the preparation method chosen the one-component baking systems of the invention comprise the above-described individual components (a) to (e), the amounts of (a)+(b) being from 20 to 89.9 parts by weight, (c) from 0.01 to 5 parts by weight, the amount of (d) from 10 to 75 parts by weight and of (e) from 0 to 10 parts by weight, with the proviso that the sum of the parts by weight of the individual components (a) to (e) is 100.

The one-component baking systems of the invention preferably comprise the above-described individual components (a) to (e) with the proviso that together they give a sum of 100 parts by weight, the amounts of (a)+(b) being from 30 to 69.9 parts by weight, (c) from 0.01 to 2 parts by weight, the amount of (d) from 30 to 70 parts by weight and (e) from 0 to 8 parts by weight.

The one-component baking systems of the invention are used to prepare baking enamels, for industrial coating, for example, and in the OEM finishing of passenger cars. These baking enamels can be, for example, primers, surfacers and topcoat materials. The baking enamels may comprise pigments or may be pure topcoat materials. For this purpose the coating compositions of the invention can be applied by knife coating, dipping, spray application such as compressed air spraying or airless spraying, and also by electrostatic application, high-speed rotating bell application for example. The dry film coat thickness can be, for example, 10-120 μm. The dry films are cured by baking in temperature ranges of 90-160° C., preferably 110-140° C., with particular preference at 120-130° C.

The substrates coated with coatings obtainable from formulations based on the one-component baking systems of the invention are likewise provided by the present invention.

The examples below illustrate the invention.

### EXAMPLES

In the examples below all percentages are by weight.

### Examples 1 to 4

Clearcoat materials of the composition below were prepared by intensively mixing the components listed in Table 1. The equivalent ratio of blocked isocyanate groups to OH groups is 1:1.

TABLE 1
Clearcoat materials

| Component | | |
|---|---|---|
| (a) | Desmodur ® VP LS 2253¹⁾ | 29.5% by wt. |
| | Bayer AG Leverkusen | |
| (b) | Desmophen ® A 870²⁾, 70% | 41.8% by wt. |
| | in butyl acetate | |
| (e) | Baysilone ® OL 17, 10% in | 0.5% by wt. |
| | xylene, Borchers GmbH, Monheim | |
| (e) | Modaflow ®, 1% in xylene | 0.5% by wt. |
| (e) | Tinuvin ® 292, 10% in xylene, | 5.2% by wt. |
| | Ciba, Basle | |
| (e) | Tinuvin ® 1130, 10% in xylene, | 10.3% by wt. |
| | Ciba, Basle | |
| (d) | 1-Methoxy-2-propyl acetate/ | 12.2% by wt. |
| | solvent naphtha 100 (1:1) | |

¹⁾Blocking agent: 3,5-dimethylpyrazole. This is a hexamethylene diisocyanate trimer, 75% by weight in MPA/SN 100 (8:17), blocked NCO content 10.5 mol %
²⁾Polyacrylate-polyol, 70% by weight in butyl acetate, OH content approx. 3% by weight.

Various molybdenum compound were admixed to these coating materials, which were then sprayed onto the glass plates and subsequently baked at 140° C. for 30 minutes. Investigated along with these, for comparison, were the catalyst DBTL and an uncatalysed system. The properties of the films obtained are listed in Table 2:

TABLE 2
Performance tests and comparative examples

| | Example No. | | | |
|---|---|---|---|---|
| | | | 3 | 4 |
| | 1 | 2 | (comparative) | (comparative) |
| Catalyst | molybdenyl | MoO₂(TMHD)₂ | DBTL | none |
| | acetylacetonate | | | |
| Amount of catalyst | 0.50 | 0.50 | 0.50 | — |
| (solids/solids) (%) | | | | |
| Baking conditions | 30′, 140° C. | 30′, 140° C. | 30′, 140° C. | 30′, 140° C. |
| Visual assessment of the | satisfactory | satisfactory | satisfactory | satisfactory |
| coating film | | | | |
| König pendulum | 140 | 148 | 137 | 101 |
| damping (swings) | | | | |
| (s) | 196 | 207 | 192 | 141 |
| Solvent resistance | | | | |
| (X/MPA/EA/Ac) | | | | |
| (rating)¹⁾ | | | | |
| 1 Min. | 0012 | 0023 | 1123 | 2244 |
| 5 Min. | 2124 | 2234 | 2244 | 3344 |

¹⁾Evaluation: 0 - good; 5 -poor; TMHD = tetramethylheptadionate; key to solvent test: X = xylene/MPA = methoxypropyl acetate/EA = ethyl acetate, acetic acid ethyl ester/Ac = acetone

It is evident that the catalysts of the invention have a much higher reactivity than the prior art (DBTL), as manifested in improved solvent resistance.

### Examples 5 to 8

Clearcoat materials of the following composition were prepared by intensively mixing the components listed in Table 3:

TABLE 3
Clearcoat materials

| Component | | |
|---|---|---|
| (a) | Desmodur ® BL 3175¹⁾, | 29.1% by wt. |
| | Bayer AG Leverkusen | |
| (b) | Desmophen ® A 870, 70% | 42.5% by wt. |
| | in butyl acetate | |
| (e) | Baysilone ® OL 17, 10% in | 0.5% by wt. |
| | xylene, Borchers GmbH, Monheim | |
| (e) | Modaflow ®, 1% in xylene | 0.5% by wt. |
| (e) | Tinuvin ® 292, 10% in xylene, | 5.1% by wt. |
| | Ciba, Basle | |
| (e) | Tinuvin ® 1130, 10% in xylene, | 10.3% by wt. |
| | Ciba, Basle | |
| (d) | 1-Methoxy-2-propyl acetate/ | 12.0% by wt. |
| | solvent naphtha 100 (1:1) | |

¹⁾Blocking agent: butanone oxime. This is a hexamethylene diisocyanate trimer, approximately 75% by weight in solvent naphtha 100, blocked NCO content 11.1 mol %. Desmophen ® A 870: polyacrylate-polyol, 70% by weight in butyl acetate, OH content 3% by weight.

Different molybdenum compounds were admixed to these coating materials, which were then sprayed onto glass plates and subsequently baked at 140° C. for 30 minutes. For comparison again a varnish catalysed with DBTL was used, and also an uncatalysed varnish. The properties of the films obtained are listed in Table 4:

TABLE 4
Performance tests and comparative examples

| | Example No. | | | |
|---|---|---|---|---|
| | | | 7 | 8 |
| | 5 | 6 | (comparative) | (comparative) |
| Catalyst | molybdenyl | MoO₂(TMHD)₂ | DBTL | none |
| | acetylacetonate | | | |
| Amount of catalyst | 0.50 | 0.50 | 0.50 | — |
| (solids/solids) (%) | | | | |
| Baking conditions | 30′, 140° C. | 30′, 140° C. | 30′, 140° C. | 30′, 140° C. |
| Visual assessment of | satisfactory | satisfactory | satisfactory | satisfactory |
| the coating film | | | | |
| König pendulum | 141 | 143 | 125 | 75 |
| damping (swings) | | | | |
| (s) | 197 | 200 | 175 | 105 |
| Solvent resistance | | | | |
| (X/MPA/EA/Ac) | | | | |
| (rating)¹⁾ | | | | |
| 1 Min. | 1022 | 0123 | 2234 | 3344 |
| 5 Min. | 2234 | 2334 | 3344 | 4444 |

¹⁾Evaluation: 0 - good; 5 - poor; TMHD = tetramethylheptadionate. Key to solvent test: X = xylene/MPA = methoxypropyl acetate/EA = ethyl acetate, acetic acid ethyl ester/Ac = acetone

It is evident that adding the molybdenum-containing catalyst as co pared with the DBTL standard allows better solvent resistance to be achieved when baking at 140° C.

Instructions for Preparing the Aqueous Self-Crosslinker for Example 11-12 (Blocking Agent Tert-Butylbenzylamine/BEBA)

26.8 g (0.4 mol) of dimethylolpropionic acid in solution in 77.84 g of N-methylpyrrolidone were added at 80° C. to 104.8 g (0.8 mol) of bis-(4,4′-isocyanatocyclohexyl)methane (Desmodur® W, Bayer AG). Then 94.0 g (0.72 mol) of Desmodur® W, 112.3 g (0.345 mol) of a linear polycaprolactone polyester, 11.25 g (0.01 mol) of a monofunctional polyether of average molar weight 2250, 6.70 g (0.1 mol) of trimethylolpropane and 4.50 g (0.1 mol) of 1,4-butanediol were added and the reaction mixture was stirred at 80° C. for seven hours until the isocyanate group content reached 4.66% (calculated 4.79%). The mixture was then cooled to 70° C. and at this temperature 65.31 g (0.4 mol) of tert-butylbenzylamine were added over the course of 60 minutes. Stirring was then carried out for 30 minutes; the NCO content was 0.75% (calculated 0.83%). Subsequently 230.0 g (0.575 eq. OH) of a branched polyester (Desmophen® 670, 4.25% by weight OH groups, Bayer AG) were added and the mixture was stirred at 70° C. for 2 hours more until free NCO groups were no longer present. Then 17.83 g (0.20 mol) of N-dimethylethanolamine were added and stirring was continued for 10 minutes. Thereafter 880.3 g of deionized water at a temperature of 70° C. were added with vigorous stirring, followed by stirring at 70° C. for 1 hour and then by cooling to room temperature accompanied by stirring. The resulting dispersion possessed the following properties:

| | | |
|---|---|---|
| Solids content: | 40% | |
| Viscosity (23° C., rotation viscometer): | 1100 | mPas |
| Particle size (LCS): | 52 | nm |

The dispersion obtained in this way was used in Examples 11 and 12 in Table 5. The preparation instructions for Examples 9 to 10 can be found below. The catalysts were each added prior to dispersing of the resin in water.

Clearcoat materials were prepared from the dispersions according to Examples 9 to 12, following the addition of Additol® 395 (1.8%, solids/solids) levelling agent and adjustment of the viscosity to approximately 35 s (DIN 4 flow cup) with deionized water, and these materials were applied by spraying to glass plates. The films obtained were tested by various methods and compared with films produced without using the catalysts of the invention. The results are listed in Table 5.

Additol® XW 395 is a levelling, wetting and anti-floating agent for water-thinnable coating systems. It contains 58% by weight of active substance. Manufacturer: Vianova Resins AG

TABLE 5
Baking temperatures of aqueous self-crosslinkers in the
presence of molybdenum catalysts - performance tests

| Example No. | | | | |
|---|---|---|---|---|
| | 10 | | 12 | 12a |
| | DIPA | | BEBA | BEBA |
| | blocked + | | blocked + | blocked + |
| 9 | lithium | 11 | lithium | sodium |
| DIPA | molybdate | BEBA | molybdate | tungstate |
| blocked | (0.75%) | blocked | (0.75%) | (1%) |

Clearcoat: binder + Additol XW 395 (1.8%) + H₂O

Pendulum hardness

| | | | | | | | | | | |
|---|---|---|---|---|---|---|---|---|---|---|
| 30′ 120° C. | 28 | s | 42 | s | 43 | s | 59 | s | 43 | s |
| 30′ 130° C. | 36 | s | 48 | s | 50 | s | 62 | s | 53 | |
| 30′ 140° C. | 53 | s | 59 | s | 53 | s | 56 | s | 54 | |

Solvent resistance (X/MPA/EA/Ac) (rating)¹⁾ after 1 minute

| | | | | | |
|---|---|---|---|---|---|
| 30′ 120° C. | 5 5 5 5 | 3 3 3 3 | 1 1 4 4 | 1 1 3 3 | 1 1 3 4 |
| 30′ 130° C. | 3 4 5 5 | 1 1 3 3 | 1 1 3 4 | 1 1 3 3 | 1 1 3 3 |
| 30′ 140° C. | 1 1 1 3 | 1 1 1 3 | 1 1 1 3 | 1 1 1 2 | 1 1 1 3 |

Evaluation: 0—good; 5—poor.
Key to solvent test: X = xylene/MPA = methoxypropyl acetate/EA = ethyl acetate, acetic acid ethyl ester/Ac = acetone

### Examples 9 to 10, 13 to 17

Preparation of the Self-Crosslinker for Examples 9-10, 13-17, 18-21, 22-23 (Comparative) and 24 (Comparative)

336.7 g of N-methylpyrrolidone were added to 789.8 g (3.71 eq NCO) of an aliphatic polyisocyanate (Desmodur® N 3300, Bayer AG, D-Leverkusen). 374.9 g (3.71 eq) of diisopropylamine were added over the course of 60 minutes, with stirring, at a rate such that the temperature did not exceed 70° C. Stirring was continued at 70° C. for 60 minutes; thereafter isocyanate groups were no longer detectable by IR spectroscopy. At 70° C. 2311 g (5.29 eq of hydroxyl groups) of a polyester polyacrylate made from a polyester polyol made from 1,6-hexanediol, trimethylolpropane, peanut oil fatty acid, maleic anhydride and phthalic anhydride and having an OH number of 136, grafted with a mixture of butyl acrylate, methyl methacrylate and hydroxypropyl methacrylate, were added and the mixture was stirred for 20 minutes. Then 115.5 g (1.296 eq) of dimethylethanolamine were added followed by stirring for 10 minutes.

Portions of 614 g of this reaction mixture were admixed at 70° C. with finely powdered lithium molybdate in the quantities indicated in Table 6 and the mixtures were stirred for 30 minutes. Then in each case 581 g of deionized water at a temperature of 70° C. were added with vigorous stirring, followed by stirring for 60 minutes and cooling, still accompanied by stirring. The dispersions obtained possessed a solids content of 45% by weight and had the other following properties:

TABLE 6

| | | Catalyst addition | | Particle | |
|---|---|---|---|---|---|
| Example | | (g) (or % | Viscosity | size (LCS) | |
| No. | Catalyst | solids/solids) | (mPas) | (nm) | pH |
| 13 | Lithium | 1.62 (0.3) | 410 | 128 | 9.3 |
| | molybdate | | | | |
| 14 | Lithium | 2.16 (0.4) | 390 | 124 | 9.2 |
| | molybdate | | | | |
| 15 | Lithium | 2.70 (0.5) | 380 | 115 | 9.3 |
| | molybdate | | | | |
| 16 | Lithium | 4.06 (0.75) | 590 | 121 | 9.3 |
| | molybdate | | | | |
| 17 | Lithium | 5.41 (1.00) | 4000 | 250 | 9.4 |
| | molybdate | | | | |

### Examples 18 to 21

The procedure described in Examples 13 to 17 was repeated but using the catalysts listed in Table 7. The resulting dispersions had the following properties:

TABLE 7

| | | Metered | | | |
|---|---|---|---|---|---|
| | | addition of | | | |
| Example | | catalyst (% | Viscosity | Particle size | |
| No. | Catalyst | solids/solids) | (mPas) | (LCS) (nm) | pH |
| 18 | Sodium | 0.26 | 320 | 113 | 9.1 |
| | molybdate | | | | |
| 19 | Sodium | 1.00 | 1800 | 108 | 9.3 |
| | molybdate | | | | |
| 20 | Potassium | 0.60 | 350 | 137 | 9.2 |
| | molybdate | | | | |
| 21 | Tetrabutyl- | 0.60 | 260 | 115 | 9.1 |
| | ammonium | | | | |
| | molybdate | | | | |

### Examples 22 and 23

The procedure described in Examples 17 and 19 was repeated but adding the catalysts to the finished dispersion. The properties of the resultant dispersions were as follows:

TABLE 8

| | | | Particle size | |
|---|---|---|---|---|
| Example No. | Viscosity | Catalyst | (LCS, nm) | pH |
| 22 | 4500 | Lithium | 130 | 9.4 |
| | | molybdate | | |
| 23 | 2000 | Sodium molybdate | 110 | 9.3 |

### Example 24 Comparative Example

The procedure of Examples 13 to 23 was repeated but without the addition of any molybdenum compound. The resulting dispersion had the following properties:

| | | |
|---|---|---|
| Solids content: | 45% | by weight |
| Viscosity (23° C.) | 390 | mPas |
| Particle size (LCS) | 133 | nm |
| pH | 9.2 | |

### Examples 25 to 36

Clearcoat materials were prepared from the dispersions according to Examples 13 to 23, following the addition of Additol® 395 (1.8%, solids/solids) levelling agent and adjustment of the viscosity to approximately 35 s (DIN 4 flow cup) with deionized water, and these materials were applied by spraying to glass plates. The films obtained were tested by various methods and compared with films produced without using the catalysts of the invention. The results are listed in Tables 9 and 10:

TABLE 9
Performance tests on clearcoat materials

| Clearcoat Example No. | | | | | | |
|---|---|---|---|---|---|---|
| 26 | 27 | 28 | 29 | 30 | 25 | 38 |
| Example No. | | | | | | |
| Product from dispersion Example No. | | | | | | |
| 13 | 14 | 15 | 16 | 17 | 24 | 37 |
| | | | | | (comparative) | (comparative) |

Coating material efflux time

| | | | | | | | | | | | | | | |
|---|---|---|---|---|---|---|---|---|---|---|---|---|---|---|
| O value | 39 | s | 35 | s | 38 | s | 39 | s | 38 | | 32 | s | 31 | s |
| After 11 d 40° C. | 47 | s | 48 | s | 64 | s | 63 | s | 43 | s | 27 | s | 26 | s |

Pendulum hardness

| | | | | | | | | | | | | | | |
|---|---|---|---|---|---|---|---|---|---|---|---|---|---|---|
| 30′ 120° C. | 53 | s | 60 | s | 70 | s | 76 | s | 84 | s | 24 | s | 49 | s |
| 30′ 130° C. | 76 | s | 70 | s | 85 | s | 87 | s | 115 | s | 29 | s | 64 | s |
| 30′ 140° C. | 95 | s | 97 | s | 102 | s | 108 | s | 125 | s | 67 | s | 113 | s |

Incipient solubility 1′

| | | | | | | | |
|---|---|---|---|---|---|---|---|
| 30′ 120° C. | 3344 | 3344 | 3344 | 3344 | 2244 | 4444 | 3444 |
| 30′ 130° C. | 2244 | 1144 | 1144 | 1144 | 1144 | 3344 | 2344 |
| 30′ 140° C. | 1134 | 1134 | 1144 | 1144 | 1144 | 1144 | 1144 |

Clearcoat testing after 11 d of storage at 40° C.

Pendulum hardness

| | | | | | | | | | | | | | | |
|---|---|---|---|---|---|---|---|---|---|---|---|---|---|---|
| 30′ 120° C. | 67 | s | 53 | s | 76 | s | 74 | s | 84 | s | 29 | s | 48 | s |
| 30′ 130° C. | 80 | s | 60 | s | 80 | s | 91 | s | 95 | s | 32 | s | 62 | s |
| 30′ 140° C. | 87 | s | 83 | s | 102 | s | 102 | s | 111 | s | 63 | s | 109 | s |

Solvent resistance (X/MPA/EA/Ac) (rating) ¹⁾ after 1′

| | | | | | | | |
|---|---|---|---|---|---|---|---|
| 30′ 120° C. | 1144 | 1144 | 1144 | 1144 | 2244 | 4444 | 2344 |
| 30′ 130° C. | 1144 | 1144 | 1144 | 1144 | 1144 | 3344 | 2234 |
| 30′ 140° C. | 1144 | 1144 | 1144 | 1144 | 1144 | 1144 | 1144 |

Key to solvent test: X = xylene/MPA = methoxypropyl acetate/EA = ethyl acetate, acetic acid ethyl ester/AC = acetone

TABLE 10
Performance tests on clearcoat materials

| Clearcoat Example No. | | | | | | | |
|---|---|---|---|---|---|---|---|
| 31 | 32 | 33 | 34 | 35 | 36 | 25 | 38 |
| Product from dispersion Example No. | | | | | | | |
| Property | | | | | | | |
| 18 | 19 | 20 | 21 | 22 | 23 | 24 | 37 |
| | | | | | | (comparative) | (comparative) |

Efflux time (DIN-Cup 4)

| | | | | | | | | | | | | | | | | |
|---|---|---|---|---|---|---|---|---|---|---|---|---|---|---|---|---|
| O value | 35 | s | 34 | s | 28 | s | 29 | s | 38 | s | 35 | s | 32 | s | 31 | s |
| After 7 d 40° C. | 27 | s | 28 | s | 26 | s | 28 | s | 46 | s | 27 | s | 27 | s | 26 | s |

Pendulum hardness

| | | | | | | | | | | | | | | | | |
|---|---|---|---|---|---|---|---|---|---|---|---|---|---|---|---|---|
| 30′ 120° C. | 66 | s | 62 | s | 52 | s | 39 | s | 67 | s | 94 | s | 24 | s | 49 | s |
| 30′ 130° C. | 91 | s | 115 | s | 92 | s | 48 | s | 92 | s | 123 | s | 29 | s | 64 | s |
| 30′ 140° C. | 122 | s | 122 | s | 105 | s | 112 | s | 111 | s | 125 | s | 67 | s | 113 | s |

Solvent resistance (X/MPA/EA/Ac) (rating)¹⁾ after 1′

| | | | | | | | | |
|---|---|---|---|---|---|---|---|---|
| 30′ 120° C. | 2 3 4 4 | 3 3 4 4 | 3 3 4 4 | 3 3 4 4 | 4 3 4 4 | 2 1 4 4 | 4 4 4 4 | 3 4 4 4 |
| 30′ 130° C. | 2 2 3 4 | 1 2 4 4 | 2 2 4 4 | 1 2 4 4 | 1 1 4 4 | 1 1 4 4 | 3 3 4 4 | 2 3 4 4 |
| 30′ 140° C. | 1 1 4 4 | 1 1 4 4 | 1 1 4 4 | 1 1 4 4 | 1 1 4 4 | 1 1 4 4 | 1 1 4 4 | 1 1 4 4 |

Clearcoat testing after 7 d of storage at 40° C.

Pendulum hardness

| | | | | | | | | | | | | | | | | |
|---|---|---|---|---|---|---|---|---|---|---|---|---|---|---|---|---|
| 30′ 120° C. | 85 | s | 62 | s | 67 | s | 53 | s | 69 | s | 84 | s | 29 | s | 48 | s |
| 30′ 130° C. | 91 | s | 91 | s | 81 | s | 59 | s | 112 | s | 116 | s | 32 | s | 62 | s |
| 30′ 140° C. | 108 | s | 106 | s | 106 | s | 106 | s | 98 | s | 132 | s | 63 | s | 109 | s |

Solvent resistance (X/MPA/EA/Ac) (rating)¹⁾ after 1′

| | | | | | | | | |
|---|---|---|---|---|---|---|---|---|
| 30′ 120° C. | 4 3 4 4 | 3 3 4 4 | 3 3 4 4 | 2 2 4 4 | 2 2 4 4 | 2 2 4 4 | 4 4 4 4 | 3 4 4 4 |
| 30′ 130° C. | 2 2 4 4 | 2 1 4 4 | 2 2 4 4 | 2 1 4 4 | 1 1 4 4 | 1 1 4 4 | 3 3 4 4 | 2 3 4 4 |
| 30′ 140° C. | 2 2 4 4 | 1 1 4 4 | 1 1 4 4 | 1 1 4 4 | 1 1 4 4 | 1 1 4 4 | 1 1 4 4 | 1 1 4 4 |

Key to solvent test: X = xylene/MPA = methoxypropyl acetate/EA = ethyl acetate, acetic acid ethyl ester/Ac = acetone

It is evident that through the addition of molybdate catalysts to the dispersion it is possible to improve the baking temperature and/or the solvent resistance. Even on relatively long storage of the dispersions this effect bleaches obtained.

### Example 37 Comparative Example

The procedure of Examples 13 to 23 was repeated but using 1.0 g of dibutyltin dilaurate instead of the molybdenum compound. The resulting dispersion had the following properties:

| | | |
|---|---|---|
| Solids content: | 45% | by weight |
| Viscosity (23° C.) | 990 | mPas |
| Particle size (LCS) | 138 | nm |
| pH | 9.2 | |

### Examples 39-43

Examples of blocked polyisocyanates which were blocked with dimethylpyrazole or butanone oxime and are water-dispersible by virtue of a PES/PAC system (based on a branched polyester and a hydroxy-functional water-dispersible acrylate). The blocked polyisocyanate used is a hexamethylene diisocyanate trimer blocked with 3,5-dimethylpyrazole (Desmodur® VP LS 2253, Bayer AG) and a hexamethylene diisocyanate trimer blocked with butanone oxime (Desmodur® BL 3175, Bayer AG). These blocked polyisocyanates were admixed with a polyester/polyacrylate resin (see above) and then dispersed in water. Dimethylethanolamine was added, the dispersions were stirred for 10 minutes and then lithium molybdate was added. Stirring was repeated for better incorporation. The percentage of the catalyst used is listed in each case.

TABLE 11
Performance tests on clearcoat materials

| | Example No. | | | | |
|---|---|---|---|---|---|
| | | 40 | 41 | | |
| | | PES/PAC/ | PES/PAC/ | | 43 |
| | 39 | LS 2253 + | LS 2253 + | 42 | PES/PAC/ |
| | PES/PAC/ | 0.75% | 0.26% | PES/PAC/ | BL 3175 + |
| | LS 2253 | lithium | sodium | BL 3175 | 1% lithium |
| | without cat. | molybdate | molybdate | without cat. | molybdate |
| Ph 0 value | 8.3 | 8.1 | 8.1 | 8.4 | 8.5 |
| after 4 wks | | | | | |
| 40° C. | | | | | |

Clearcoat: binder + Additol ® XW 395 (1.8%) + H₂O

Ft (DIN 4 Cup)

| | | | | | |
|---|---|---|---|---|---|
| 0 value | 39 s | 36 s | 36 s | 35 s | 38 s |
| after 7 d 40° C. | 24 s | 24 s | 25 s | 24 s | 29 s |

Pendulum hardness instantan./after 7 d 40° C.

| | | | | | |
|---|---|---|---|---|---|
| 30′ 120° C. | 24 s/36 s | 66 s/78 s | 43 s/69 s | 6 s/7 s | 7 s/13 s |
| 30′ 130° C. | 38 s/53 s | 97 s/98 s | 62 s/91 s | 11 s/18 s | 27 s/36 s |
| 30′ 140° C. | 126 s/106 s | 139 s/108 s | 118 s/95 s | 94 s/45 s | 127 s/106 s |
| 30′ 150° C. | — | — | — | 120 s/73 s | 147 s/134 s |

Solvent resistance (X/MPA/EA/Ac) (rating)¹⁾ after 1′ instantan./after 7 d 40° C

| | | | | | |
|---|---|---|---|---|---|
| 30′ 120° C. | 3344/4344 | 2144/1144 | 3344/4344 | 5555/5555 | 4455/4445 |
| 30′ 130° C. | 1144/1144 | 1144/1144 | 2244/1144 | 4444/4444 | 2244/4345 |
| 30′ 140° C. | 1144/1144 | 1144/1144 | 3244/1144 | 4344/2244 | 1144/1144 |
| 30′ 150° C. | — | — | — | 1144/1144 | 1144/1144 |

0—good; 5—poor;
Ft = flow time.
Key to solvent test: X = xylene/MPA = methoxypropyl acetate/EA = ethyl acetate, acetic acid ethyl ester/Ac = acetone
Additol ® XW 395 is a levelling, wetting and anti-floating agent for water-thinnable coating systems. It contains approximately 58% of active substance. Manufacturer: Vianova Resins AG

The average particle sizes (the numerical average is stated) of the PU dispersions was determined by means of laser correlation spectroscopy (instrument: Malvern Zetasizer 1000, Malvern Instruments Ltd).

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Polyurethane-based one-component baking systems comprising one or more organic and/or inorganic compounds of molybdenum and/or of tungsten in which the molybdenum and/or tungsten has an oxidation state of at least +4.

2. The systems according to claim 1, wherein the compounds of molybdenum and/or of tungsten are compounds selected from the group consisting of ammonium molybdate, lithium molybdate, sodium molybdate, potassium molybdate, rubidium molybdate, caesium molybdate, ammonium paramolybdate (NH₄)₆Mo₇O₂₄.4H₂O, molybdenyl bisacetylacetonate MoO₂(C₅H₇O₅)₂, molybdenum dioxide tetramethylheptadionate MoO₂(TMHD)₂, molybdenum alkoxides formed from 1,2-, 1,3- or 1,4-diols such as ethylene glycol, propylene glycol or 1,4-butanediol-molybdic acid, molybdenum oxides, tetraethylammonium molybdate, sodium tungstate, magnesium molybdate, calcium molybdate, tungstic acid, lithium tungstate and phosphotungstic acid.

3. The systems according to claim 1, wherein the compounds of molybdenum and/or of tungsten are compounds selected from the group consisting of ammonium molybdate, lithium molybdate, sodium molybdate, potassium molybdate, rubidium molybdate, caesium molybdate, ammonium paramolybdate (NH₄)₆Mo₇O₂₄.4H₂O, molybdenyl bisacetylacetonate MoO₂(C₅H₇O₅)₂, molybdenum dioxide tetramethylhept-adionate MoO₂(TMHD)₂, molybdenum alkoxides formed from 1,2-, 1,3- or 1,4-diols such as ethylene glycol, propylene glycol or 1,4-butanediol-molybdic acid, molybdenum oxides, tetraethylammonium molybdate and sodium tungstate.

4. A polyurethane-based one-component baking systems comprising
(a) blocked polyisocyanates,
(b) polymers having polyisocyanate-reactive groups,
(c) one or more organic and/or inorganic compounds of molybdenum and/or of tungsten in which the molybdenum and/or tungsten has an oxidation state of at least +4,
(d) water and/or organic solvents or solvent mixtures and
(e) if desired, further additives and auxiliaries,
wherein the amounts of (a)+(b) are from 20 to 89.9 parts by weight, (c) is from 0.01 to 5 parts by weight, (d) is from 10 to 70 parts by weight and (e) is from 0 to 10 parts by weight and the sum of the parts by weight of components (a) to (e) is 100.

5. The systems according to claim 1, further comprising aliphatic isocyanates as blocked polyisocyanates (a).

6. The systems according to claim 1, further comprising aromatic isocyanates as blocked polyisocyanates (a).

7. The systems according to claim 1, further comprising polyisocyanates based on hexamethylene diisocyanate, isophorone diisocyanate, 4,4′-diisocyanatodicyclohexylmethane, their derivatives and/or mixtures as blocked polyisocyanates (a).

8. The systems according to claim 1, further comprising hydrophilicized polyisocyanates.

9. The systems according to claim 1, wherein salts of molybdic and/or tungstic acid or condensation products thereof are used as the molybdenum compound and/or tungsten compound.

10. The systems according to claim 1, wherein ortho- and meta-molybdates and/or—tungstates of lithium, sodium and potassium are used as the molybdenum compound and/or tungsten compound.

11. A process for preparing the systems according to claim 1 comprising introducing the organic and/or inorganic compounds of molybdenum and/or of tungsten into blocked polyisocyanates and/or polymers having polyisocyanate-reactive groups prior to dispersing or dissolution thereof in water and/or organic solvents or solvent mixtures.

12. A process for preparing the systems according to claim 1 comprising introducing the organic and/or inorganic compounds of molybdenum and/or of tungsten into water and/or organic solvents or solvent mixtures prior to the dispersing or dissolution of blocked polyisocyanates and/or polymers having polyisocyanate-reactive groups in the same.

13. A process for preparing aqueous or water-dispersible systems according to claim 1 comprising adding organic and/or inorganic compounds of molybdenum and/or of tungsten to one or more materials selected from the group consisting of blocked polyisocyanates, polymers having polyisocyanate-reactive groups, organic solvents, and optionally further additives and auxiliaries, before adding dispersing water.

14. A method of preparing paints, inks and adhesives comprising adding to the systems according to claim 1, one or more materials selected from the group consisting of pigments, fillers, levelling agents, defoamers, catalysts other than organic and/or inorganic compounds of molybdenum and/or of tungsten, and mixtures thereof.

15. Substrates coated with coatings obtainable from the systems according to claim 1.

16. The systems according to claim 4, wherein aliphatic isocyanates are used as blocked polyisocyanates (a).

17. The systems according to claim 4, wherein aromatic isocyanates are used as blocked polyisocyanates (a).

18. The systems according to claim 4, wherein polyisocyanates based on hexamethylene diisocyanate, isophorone diisocyanate, 4,4′-diisocyanatodicyclohexylmethane, their derivatives and/or mixtures are used as blocked polyisocyanates (a).

19. The systems according to claim 4, wherein the polyisocyanates (a) are hydrophilicized.

20. The systems according to claim 4, wherein salts of molybdic and/or tungstic acid or condensation products thereof are used as molybdenum compound and/or tungsten compound (c).

21. The systems according to claim 4, wherein ortho- and meta-molybdates and/or—tungstates of lithium, sodium and potassium are used as molybdenum compound and/or tungsten compound (c).

22. A process for preparing the systems according to claim 4 comprising introducing component (c) into components (a) and/or (b) prior to the dispersing or dissolution thereof in component (d).

23. A process for preparing the systems according to claim 4 comprising introducing component (c) into component (d) prior to the dispersing or dissolution of component (a) and/or (b) in the same.

24. A process for preparing aqueous or water-dispersible systems according to claim 4 comprising adding component (c) to one or more of components (a), (b), (d) and/or (e) before adding dispersing water.

25. A method of preparing paints, inks and adhesives comprising adding to the systems according to claim 4, one or more materials selected from the group consisting of pigments, fillers, levelling agents, defoamers, catalysts other than (c), and mixtures thereof.

26. Substrates coated with coatings obtainable from the systems according to claim 4.

27. The systems according to claim 4, wherein the compounds of molybdenum and/or of tungsten are compounds selected from the group consisting of ammonium molybdate, lithium molybdate, sodium molybdate, potassium molybdate, rubidium molybdate, caesium molybdate, ammonium paramolybdate (NH₄)₆Mo₇O₂₄.4H₂O, molybdenyl bisacetylacetonate MoO₂(C₅H₇O₅)₂, molybdenum dioxide tetramethylheptadionate MoO₂(TMHD)₂, molybdenum alkoxides formed from 1,2-, 1,3- or 1,4-diols such as ethylene glycol, propylene glycol or 1,4-butanediolmolybdic acid, molybdenum oxides, tetraethylammonium molybdate, sodium tungstate, magnesium molybdate, calcium molybdate, tungstic acid, lithium tungstate and phosphotungstic acid.

28. The systems according to claim 4, wherein the compounds of molybdenum and/or of tungsten are compounds selected from the group consisting of ammonium molybdate, lithium molybdate, sodium molybdate, potassium molybdate, rubidium molybdate, caesium molybdate, ammonium paramolybdate (NH₄)₆Mo₇O₂₄.4H₂O, molybdenyl bisacetylacetonate MoO₂(C₅H₇O₅)₂, molybdenum dioxide tetramethylheptadionate MoO₂(TMHD)₂, molybdenum alkoxides formed from 1,2-, 1,3-or 1,4-diols such as ethylene glycol, propylene glycol or 1,4-butanediolmolybdic acid, molybdenum oxides, tetraethylammonium molybdate and sodium tungstate.
